(19) United States
(12) Patent Application Publication
(10) Pub. No.: US 2003/0140798 A1
(43) Pub. Date: Jul. 31, 2003

(54) Sealed infrared broiler for outdoor barbecue

(76) Inventors: Randy L. Rummel, Huntington Beach, CA (US); Eric H. Y. Deng, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/060,906

(22) Filed: Jan. 29, 2002

(51) Int. Cl. A47J 37/04

(52) U.S. Cl. 99/419

(57) ABSTRACT

A gas barbecue is described, comprising a hinged lid, an interior cooking space with a rotisserie rod mountable therein, a gas infrared broiler assembly mounted at a periphery of the cooking space, and an infrared-transparent panel held by a plenum disposed between the broiler and the cooking space. The broiler assembly is preferably mounted in a substantially vertical plane at the rear of the cooking space, and enclosed by the plenum such that flue products are substantially prevented from entering the cooking space. Heating and cooking of the food product is therefore limited to infrared radiation through the glass panel. Additionally, the barbecue may include a substantially horizontal cooking grill, and a heating element disposed underneath the grill.

### BACKGROUND OF THE INVENTION

1. Field of the Invention

This invention relates generally to gas barbecues and, more particularly, the invention relates to a gas infrared broiler mounted on a gas barbecue.

2. Description of the Related Art

Many modern gas barbecues with a gas rotisserie feature have an infrared broiler located vertically behind a rotating rotisserie rack with the heated media exposed to the food. Infrared broilers are used in many cooking applications where heating by infrared radiation is desired. By positioning such a broiler at the back of a barbecue, the water and oils from the food product do not fall onto the heated surface causing flare-ups. Typically, the broiler surface is exposed to the cooking space of the barbecue.

Leaving the burning surface exposed creates several disadvantages in this arrangement. First, flue products from the gas broiler directly contacting the food causes the food to be both baked by the flue products and broiled by the infrared radiation of the broiler. This often results in over-cooking the outside and under-cooking on the inside of the food. Additionally, leaving the combustion surface exposed to wind, rain, or other undesirable weather conditions makes it difficult to obtain a stable flame causing poor combustion and undesirable gas emission. Furthermore exposure to adverse environmental conditions combined with potential contact with the user leaves the broiler susceptible to cracking and other damage.

It is therefore desirable to have a gas barbecue in which contact between flue products and food can be minimized or eliminated, food products are cooked by pure radiation only, and the broiler assembly can be protected.

### SUMMARY OF THE INVENTION

Thus, one embodiment of a gas barbecue having preferred features and advantages includes an interior cooking space, defined by a plurality of side walls, at least two of the side walls being adapted to have a rotisserie rod mountable therebetween such that the rotisserie has a central portion within the cooking space. A gas infrared broiler assembly is mounted at a periphery of the cooking space, and an infrared-transparent panel is disposed between the broiler and the cooking space. The panel may be mounted to a plenum disposed within the barbecue such that the broiler assembly is enclosed by the plenum. The plenum and panel substantially prevent flue products from entering the cooking space. A venting system may be provided to vent flue products outside the barbecue. The panel is preferably made of ceramic glass, thus allowing infrared radiation to be transmitted therethrough

In one embodiment, the broiler assembly is mounted in a substantially vertical plane at the rear of the cooking space. The rotisserie rod is preferably positioned such that radiant heat from the broiler assembly will reach a food product disposed on the rod. The broiler may comprise a combustion media made of ceramic tile or wire mesh, and may comprise a hot surface ignitor or a direct spark ignition. The broiler may further comprise an adjustable air shutter.

The barbecue may also include reflectors adapted to deflect radiation and improve heating efficiency and/or a catalyst for reducing undesirable flue products. The barbecue may further comprise a horizontal grill and an under-grill gas burner, and the infrared broiler assembly may be perpendicular to the cooking grill.

Another embodiment of a gas barbecue having desired features and advantages includes an interior cooking space defined by at least one upright wall and a horizontal grill, the grill being located at the bottom of the cooking space, a rotisserie rod mountable within the cooking space, a gas infrared broiler assembly mounted at a periphery of the cooking space and oriented to radiate heat into the cooking space, and an infrared-transparent panel disposed between the broiler and the cooking space. The panel is preferably made of ceramic glass, and held by a plenum. The barbecue may also include a gas burner mounted under the cooking grill, and a venting system to substantially prevent flue products from entering the cooking chamber. The broiler may be gas universal, gas specific, powered burner type, or atmospheric, and the broiler combustion media may be made of wire mesh or a porous ceramic tile.

In one embodiment, the broiler and panel are vertically oriented, and the panel is substantially larger than the broiler assembly. The rotisserie rod is mountable in the cooking space such that a food product disposed on the rod will be heated by infrared radiation from the broiler assembly.

For purposes of summarizing the barbecue and the advantages achieved over the prior art, certain objects and advantages have been described herein above. Of course, it is to be understood that not necessarily all such objects or advantages may be achieved in accordance with any particular embodiment. Thus, for example, those skilled in the art will recognize that a barbecue may be embodied or carried out in a manner that achieves or optimizes one advantage or group of advantages as taught herein without necessarily achieving other objects or advantages as may be taught or suggested herein.

All of these embodiments are intended to be within the scope of the present discussion. These and other embodiments will become readily apparent to those skilled in the art from the following detailed description of the preferred embodiments having reference to the attached figures, the barbecue not being limited to any particular preferred embodiment(s) disclosed.

### BRIEF DESCRIPTION OF THE DRAWINGS

Having thus summarized the general nature of the invention, certain preferred embodiments and modifications thereof will become apparent to those skilled in the art from the detailed description herein having reference to the figures that follow, of which:

FIG. 1 is a perspective view of a barbecue having preferred features and advantages;

FIG. 2 is a perspective view, partially in cut-away, showing features of the barbecue of FIG. 1;

FIG. 3 is a section view of a plenum and gas broiler assembly having preferred features and advantages; and

FIG. 4 is an exploded orthogonal view of the plenum and gas broiler assembly of FIG. 3.

### DETAILED DESCRIPTION OF THE PREFERRED EMBODIMENT

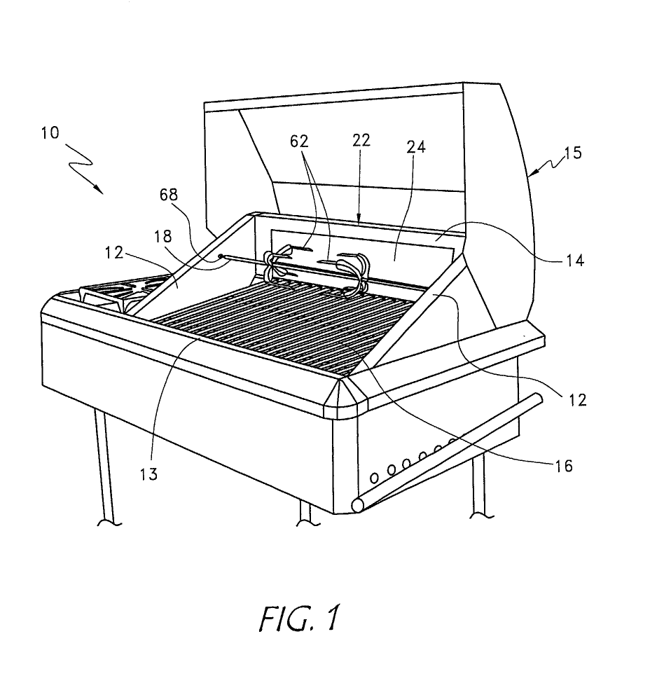

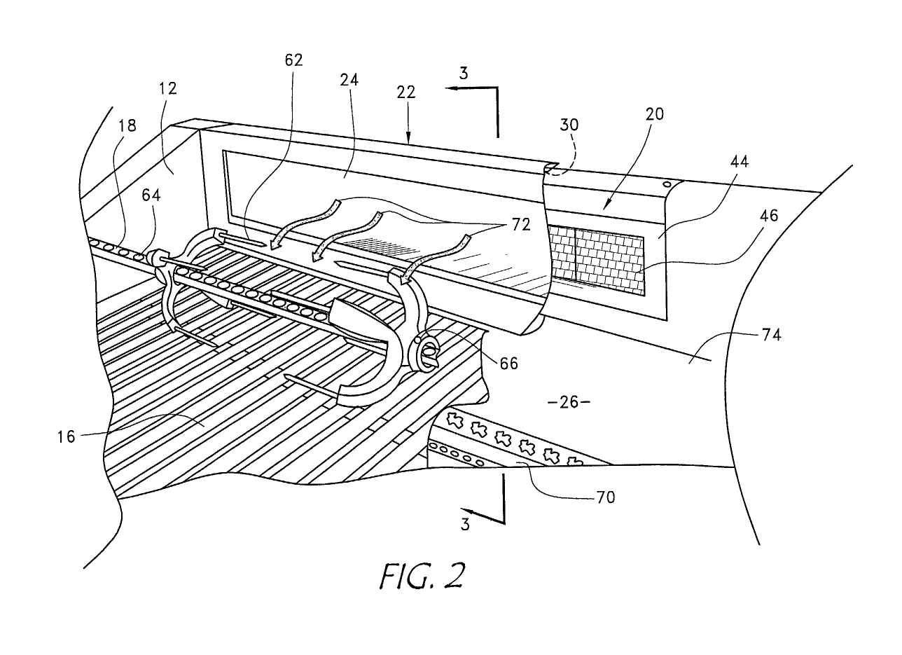

FIGS. 1 and 2 show one embodiment of a gas barbecue 10 having desired features and advantages. Specifically, FIG. 1 shows a barbecue 10 with a cooking space defined by a pair of side walls 12 extending from the front 13 to the back 14 of the barbecue 10, a hinged lid 15, and a grill 16. A rotisserie rod 18 is preferably positioned within the cooking space of the barbecue 10. The barbecue 10 preferably includes an under-grill space 26 defined by a plurality of vertical walls and a bottom. Above the level of the grill 16, the barbecue 10 includes side walls 12 extending from the front 13 to the back 14 of the barbecue 10. In one embodiment, the side walls 12 are substantially sloped upward from front 13 to rear 14. The barbecue 10 preferably includes an infrared broiler assembly 20 enclosed by a metallic plenum 22 having an infrared-transparent panel 24 disposed between the broiler assembly 20 and the cooking space.

The broiler assembly 20 and plenum 22 are preferably disposed such that they intersect the side walls 12 at the rear of the cooking space. The broiler 20 is preferably disposed in an orientation suitable for directing infrared radiation from the broiler to the cooking space. Alternatively, those skilled in the art will recognize that the broiler assembly 20 may be positioned at other peripheral locations of the cooking space such that the features and advantages taught herein are realized. For example, the broiler assembly 20 may be positioned at the top of the cooking space, and oriented to radiate heat vertically downward into the cooking space.

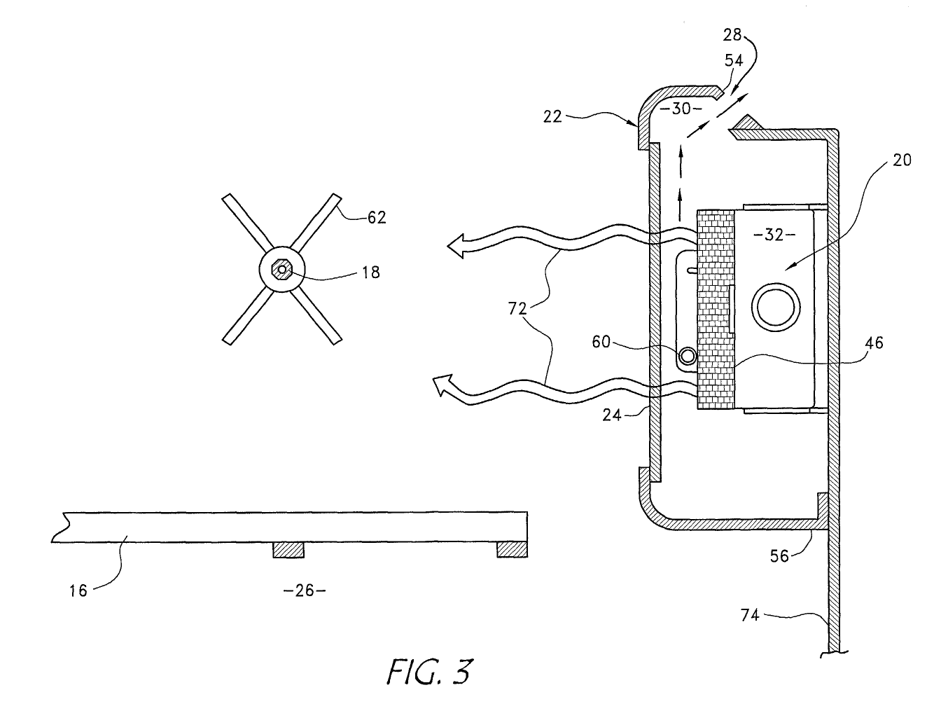

As seen in FIGS. 2 and 3, the broiler assembly 20 is preferably mounted within the plenum 22 to create an internal plenum space 30. The plenum 22 preferably has at least one flue outlet 28 adapted to be in fluid communication with the exterior of the barbecue. As discussed below, the plenum 22 and flue outlets 28 vent flue gasses out of the barbecue such that they do not enter the cooking space. In one embodiment, the lid 15 of the barbecue is adapted such that when it is in a closed position, the flue outlets 28 are open to the barbecue exterior.

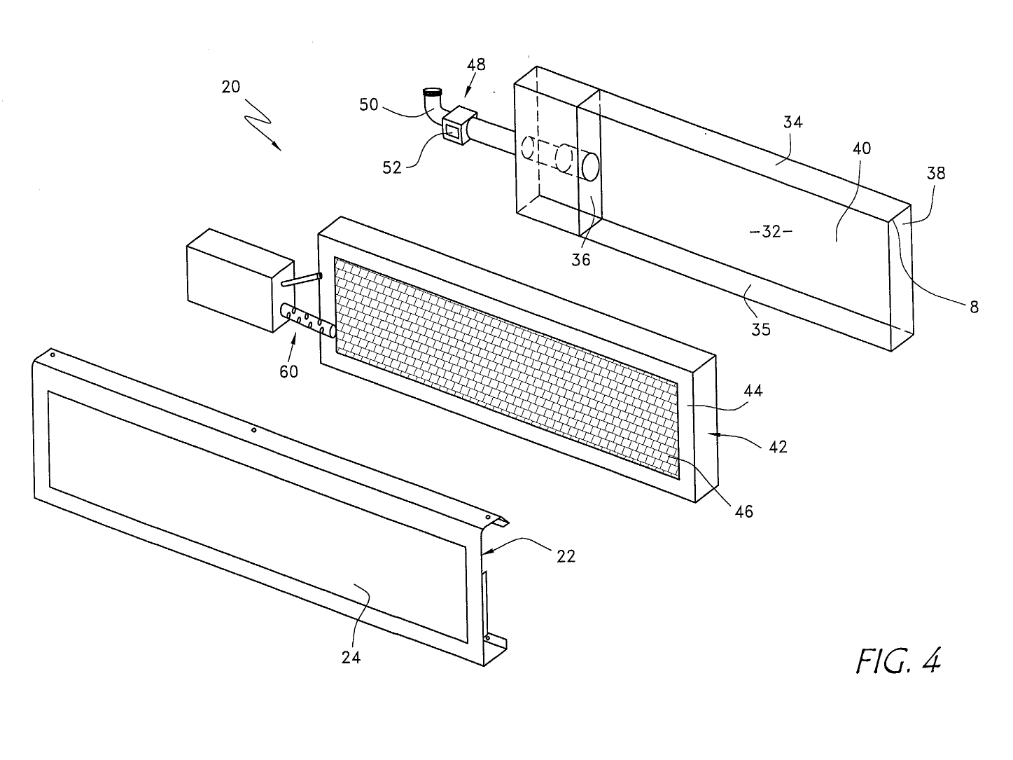

As shown in greater detail in FIGS. 3 and 4, there is illustrated an infrared broiler 20 comprising a combustion space 32 defined by horizontal top and bottom-walls 34, 35 extending longitudinally between the sides of the barbecue, first and second end walls 36, 38, a rear wall 40, and a front wall 42 comprising a frame 44, and a combustion media 46. The combustion media 46 includes one or more layers of infrared-radiating mesh or ceramic tile. The combustion media 46 may substantially fill the combustion space 32. Extending through an end wall 36 or 38 or the top 34 or bottom 35 wall, and into the combustion space 32 is a venturi 48, having a generally elongated and cylindrically shaped body. A gas orifice 50 enters an end of the venturi 48, and an air shutter opening 52 is located immediately downstream of the gas orifice 50.

The combustion media 46 used in the broiler 20 may be made of a nickel-chromium alloy which is available under the trademark Inconel which is generally suitable for use in applications requiring a high resistance to heat and corrosion. Two preferable alloys of Inconel which can be used are alloy 600 and alloy 601, both of which have excellent mechanical properties, are easily formed, and can be used in applications involving temperatures up to and above 2000° F. This material also has desirable thermal properties, such as heat absorption and radiation. The combustion media material is preferably in a form that enables the flue products to readily flow therethrough. Of course, those skilled in the art will recognize that other materials, such as ceramic tile or other porous materials, having the necessary characteristics may also be employed.

The venturi 48 of the broiler assembly 20 is preferably located centrally on one end of the broiler assembly 20. Alternatively, the venturi 48 may be located at any other point along the length of the broiler such that it functions as desired. Those skilled in the art will recognize that the broiler may be atmospheric or powered-burner type. The broiler assembly 20 preferably includes an ignitor 60 located at a periphery of the broiler frame 44. The ignitor 60 may include a hot surface ignitor, direct spark ignition, or other ignition device known to be suitable for igniting broilers. A suitable broiler is shown and described in co-pending U.S. application No. 09/843434 to Rummel which is incorporated herein by reference in its entirety.

As shown in FIGS. 2 and 3, the broiler assembly 20 is preferably mounted to the back wall 74 by a the plenum 22 which comprises at least top and front surfaces, and may include a bottom surface. The plenum 22 may also include a porcelain enamel piece disposed immediately above the broiler assembly. The plenum 22 preferably comprises a top 54 which includes a flue outlet 28, a bottom 56, and a back which comprises a portion of the barbecue back wall 74.

FIGS. 3 and 4 illustrate an embodiment of a plenum 22 having preferred features and advantages. The plenum 22 preferably has a generally partial rectangular shape when viewed in cross-section. The plenum 22 of the embodiment shown in FIGS. 2 and 3 is in relatively close proximity to the broiler assembly 20, however those skilled in the art will recognize that the plenum 22 may be adapted to be disposed closer to, or further from from the broiler assembly 20 such that the plenum space 30 comprises a smaller or larger internal volume.

The plenum 22 which encloses the broiler is preferably made of stainless steel or other material capable of withstanding high temperatures and moisture. The plenum 22 is preferably attached to the rear wall 74 such that there is a minimum of air flow between the plenum 22 and the cooking space. The plenum 22 may be fixedly attached to the barbecue 10 by welds, adhesives, rivets, or other non-removable fasteners. Alternatively, a combination of removable and non-removable fasteners may be used.

With continued reference to FIGS. 3 and 4, the front of the plenum 22 comprises an infrared-transparent panel 24. The panel 24 is preferably a highly infrared-transparent ceramic-glass having low thermal expansion properties and sufficient mechanical strength for use in a barbecue as described herein. As a result of its low thermal expansion, the material can be subjected to high temperatures while maintaining its stability of form. One suitable material for the panel is sold under the trademark Robax. Of course, other materials may be employed which are substantially transparent to infrared radiation and can withstand the temperatures involved, while maintaining adequate mechanical strength.

The area of the infrared-transparent panel 24 is preferably greater than the area of the outer surface of the broiler combustion media 46 (i.e. the panel is preferably up to 6 inches larger than the broiler in each dimension). This enables the radiant heat energy from the broiler to more completely reach the cooking space. The plenum 22 may include lenses, reflectors, or other optical devices to focus and/or direct the radiant heat energy within the cooking space.

With reference now to FIG. 1, the interior of the barbecue 10 preferably comprises a substantially reflective surface, such as polished stainless steel, in order to minimize the heat absorption of the barbecue walls 12 and lid 15. Minimizing heat absorption by the barbecue walls will allow a minimum of heat loss to the outside of the barbecue 10, thus retaining a maximum of heat energy for cooking a food product. Those skilled in the art will recognize that other finishes may be desirable for use on the interior surface of the barbecue 10.

As seen in FIG. 2, the rotisserie rod 18 is preferably hexagonal in cross section, although it may comprise a circular, square, octagonal, or other cross sectional shape. The rod 18 preferably comprises a pointed tip at one end for piercing the food product to be cooked on the rotisserie. The end opposite the tip is preferably adapted to be received within a drive assembly. The drive assembly preferably includes an electric motor for rotating the rod 18 and food product attached thereto. The rod 18 is also preferably adapted to receive food-engaging prongs 62. The prongs 62 are preferably slidably mountable on the rod 18. In one embodiment, the rod 18 includes locating slots 64 along its length, and the prongs 62 include pins or set screws 66 which may engage with the slots 64 in order to secure the prongs 62 in a desired position along the rod 18. The ends of the rod 18 preferably rotatably rest on supports 68. The supports 68 may comprise roller bearings, slots in the sides of the barbecue housing, or other type of support known to be suitable.

With reference again to FIGS. 1&2, the barbecue 10 may also include a horizontal cooking grill 16 for cooking non-rotisserie items. According to this embodiment, a gas broiler or burner assembly 70 may be disposed below the cooking grill 16 in order to provide even heat distribution for food positioned directly on the cooking grill 16. The below-grill gas burners may comprise a broiler-type burner as described above, a tube-type gas burner, combination of the two, or any other suitable burner for use in barbecues. A heat-absorbing and -radiating material may also be disposed in the space under the grill to absorb heat from the below-grill heating element, and radiate it to the food on the grill.

The operation of the gas broiler 20 will now be described with reference to FIGS. 2-4. During operation of the gas broiler 20, gas from the gas inlet orifice 50 enters the venturi 48, drawing with it primary air through the air shutter opening 52 to mix with the stream of gas entering the combustion space 32. This air-gas mixture then fills the combustion space 32 and is ignited by the ignitor 60. The burning gases cause the combustion media 46 to heat up rapidly to a red-hot glow, thus radiating heat energy outward through the glass panel 24 into the cooking space to heat food products in the barbecue, as illustrated by the arrows 72. The panel 24 and the surrounding barbecue wall 74, prevent the broiler flue products from entering the cooking space, and instead cause the flue products to flow through the plenum space 30 and out through the flue outlets 28 in the top rear portion of the plenum 22. The flow of flue products through the outlets 28 is driven by the pressure gradient between the gasses in the plenum space 30, and the atmospheric air outside the barbecue. The higher pressure gasses within the plenum 22 will follow the path of least resistance and will flow out of the plenum 22 through the outlets 28 located in the rear wall 74 as discussed above. In one embodiment, a catalyst is used to break down undesirable flue products before venting them to the atmosphere through the flue outlets 28.

In a barbecue with the preferred features and advantages described, the broiler surface and ignition device 60 are protected by the plenum 22 and ceramic-glass panel 24. This arrangement will improve flame characteristics and stability, as well as better protecting the broiler components (i.e. ignitor, infrared-radiating combustion media, venturi, etc) from wind and rain. Undesirable conditions such as flame lifting, blow-off, and poor combustion will also be minimized. These factors will result in improved reliability and increased lifetime of the broiler assembly.

Although certain preferred embodiments and examples have been described herein, it will be understood by those skilled in the art that the present inventive subject matter extends beyond the specifically disclosed embodiments to other alternative embodiments and/or uses of the invention and obvious modifications and equivalents thereof. Thus, it is intended that the scope of the present inventive subject matter herein disclosed should not be limited by the particular disclosed embodiments described above, but should be determined only by a fair reading of the claims that follow.

What is claimed is:

1. A gas barbecue comprising:
an interior cooking space, defined by a plurality of side walls, at least two of said side walls being adapted to have a rotisserie rod mountable therebetween such that said rotisserie has a central portion within said cooking space;
a gas infrared broiler assembly mounted at a periphery of said cooking space; and
an infrared-transparent panel disposed between said broiler and said cooking space.

2. The barbecue of claim 1, wherein said panel is mounted to a plenum, said plenum being disposed such that said broiler assembly is enclosed by said plenum.

3. The barbecue of claim 1, wherein said broiler assembly is mounted in a substantially vertical plane.

4. The barbecue of claim 2, wherein the plenum and infrared-transparent panel substantially prevent flue products from entering the cooking space.

5. The barbecue of claim 4 further comprising a venting system to vent flue products outside of the barbecue.

6. The barbecue of claim 1, wherein the infrared-transparent panel is made of ceramic glass.

7. The barbecue of claim 3, wherein said broiler assembly is mounted at the rear of said cooking space.

8. The barbecue of claim 7, wherein said rotisserie rod is positioned such that radiant heat from said broiler assembly will reach a food product disposed on said rod.

9. The barbecue of claim 1, wherein the broiler comprises a combustion media made of ceramic tile.

10. The barbecue of claim 1, wherein the broiler assembly comprises a hot surface ignitor.

11. The barbecue of claim 1, wherein the broiler assembly comprises a direct spark ignition.

12. The barbecue of claim 1 additionally comprising reflectors adapted to deflect radiation and improve heating efficiency.

13. The barbecue of claim 5 additionally comprising a catalyst for reducing undesirable flue products.

14. The barbecue of claim 5 additionally comprising an adjustable air shutter.

15. The barbecue of claim 2 additionally comprising a horizontal grill.

16. The barbecue of claim 15 additionally comprising an under-grill gas burner.

17. The barbecue of claim 15, wherein the infrared broiler assembly is perpendicular to the cooking grill.

18. A gas barbecue comprising:
an interior cooking space defined by at least one upright wall and a horizontal grill, said grill being located at the bottom of said cooking space;
a rotisserie rod mountable within said cooking space;
a gas infrared broiler assembly mounted at a periphery of said cooking space and oriented to radiate heat into said cooking space; and
an infrared-transparent panel disposed between said broiler and said cooking space.

19. The barbecue of claim 18 further comprising a gas burner mounted under said cooking grill.

20. The barbecue of claim 19 wherein said panel is held by a plenum.

21. The barbecue of claim 20 further comprising a venting system to substantially prevent flue products from entering the cooking space.

22. The barbecue of claim 21, wherein said infrared-panel is made of ceramic glass.

23. The barbecue of claim 22, wherein said broiler is gas universal.

24. The barbecue of claim 22, wherein said broiler is gas specific.

25. The barbecue of claim 22, wherein said broiler is powered burner type.

26. The barbecue of claim 22, wherein said broiler is atmospheric.

27. The barbecue of claim 22 wherein said broiler combustion media is made of wire mesh.

28. The barbecue of claim 22, wherein said broiler combustion media is made of a porous ceramic tile

29. The barbecue of claim 22, wherein the panel is vertically oriented.

30. The barbecue of claim 22, wherein the panel is substantially larger than the broiler assembly.

31. The barbecue of claim 30, wherein said rotisserie rod is mountable in said cooking space such that a food product disposed on said rod will be heated by infrared radiation from said broiler assembly.
